(19) United States
(12) Patent Application Publication
(10) Pub. No.: US 2007/0297111 A1
(43) Pub. Date: Dec. 27, 2007

(54) LOW FREQUENCY SWITCH

(76) Inventor: Jerry Watson Lowe, Albany, KY (US)

Correspondence Address: JERRY WATSON LOWE, RR 2 BOX 132, ALBANY, KY, 42602, US

(21) Appl. No.: 11/426,690

(22) Filed: Jun. 27, 2006

(51) Int. Cl. H02H 3/00

(52) U.S. Cl. 361/62

(57) ABSTRACT

When a generator shuts down intentionally or un-intentionally the low frequency switch disconnects a load from a generator before the output frequency of the generator drops below a preset frequency. Without the low frequency switch on some loads, such as a motor, the current will rise to several times the running current of the motor before the generator coasts to a stop. If this load is switched over to a source with insufficient capability to handle the high current, caused by low frequency operation of the load, serious damage can take place to the new source.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to a low frequency switch to disconnect an electrical device from an alternating current voltage source when the frequency is below a preset frequency.

### PRIOR ART

None found.

### DESCRIPTION OF RELATED ART

None found

With no prior art found there is a need for a mechanism to disconnect an electrical load from its power source when the frequency of the alternating current drops below a safe level.

This drop in frequency typically happens when an alternating current electrical power source has enough stored momentum to continue to rotate after shut down. Fossil fuel driven generators are an example of power sources that slow down instead of disconnecting. Since the frequency of these generators is determined by the rotation speed of the generator when the speed slows and the frequency decreases some connected devices may exceed their maximum current ratings. For example an electric motor designed to operate at a given frequency will rise in current very rapidly as the frequency is lowered. Transformers that are designed to operate at a set frequency can also exceed their maximum current rating.

The low frequency switch is needed in industry, for hospitals, emergency facilities, government agencies and other organizations that require uninterrupted power. Generally, utilities supply very frequency stable power, but the use of generator and inverter power is becoming more prevalent in modern society. In several incidents for example, the electric houseboat, (U.S. Pat. No. 6,957,990) uses generator power and backup power for the generator is a battery, powered inverter. In other applications generators are used as backup for utility power and inverter power for backup for the generators.

In some areas of emergency operations equipment must be on continuously with out any down time, even for automatic start up of a generator. These backup inverters must be able to function with a generator and switch their load back and forth between the generator and the inverter even if the load is frequency sensitive.

### Another Example

The electric houseboat (U.S. Pat. No. 6,957,990) has a 150 KW three-phase 60 Hz AC diesel generator to supply power for all functions of the electric houseboat. One of the functions is to operate the heat pump from the generator when the generator is running. If the generator is not running, a relay (with normally open and normally closed contacts) was installed to switch the heat pump over to the inverter and continue to heat or cool the houseboat. The relay coil is powered from the generator source.

### Problem Encountered:

When the Generator starts and comes up to voltage the relay closes and switches the heat pump from the inverter power source to the generator power source. This function operates as expected and the heat pump continues to operate without a problem. The problem occurs when the generator stops running while the heat pump is operating. A major shutdown of the inverter takes place. The cause of the inverter shutdown is the fact that the generator does not disconnect it's electric load, but instead starts to slow down causing the frequency of the AC power to lower. The relay fails to drop out until the frequency has lowered to a point causing the heat pump compressor to rise to extremely high current. Then the relay drops out and the compressor is switched over to the inverter. The inverter is not capable of withstanding the overload, and the inverter shuts down or is seriously damaged. Also the compressor motor can be damaged from the extreme high currents caused by operating from the low frequency.

### Possible Solutions:

One obvious solution is to cause the relay to turn off when the generator is switched off. The only problem with this solution is that the generator may shut down for reasons other than an intentional shut down, causing the same inverter overload. Another obvious possible solution is to run the frequency sensitive load from the battery-powered inverter 100% of the time. This forces the battery charging system for the inverter battery to supply the inverter current needed to operate the load plus current to charge the battery. This is an inefficient alternative that requires either a larger battery charger or will reduce the current available to charge the battery.

### OBJECTS AND ADVANTAGES

### This Patent's Unobvious Resolution to the Problem:

The electronic circuits of this patent uses a cycle timer circuit to detect a low frequency condition from the generator and causes a relay to drop out before the frequency drop causes high currents in the load device (in this case the heat pump compressor). This patent application will describe two different methods of measuring the cycle length of the frequency and causing disconnect of the voltage source to a frequency sensitive load.

The first is the preferred embodiment and is an analog solution. In this embodiment a circuit is described that uses a linear increasing voltage starting near zero at the beginning of each cycle. The voltage will increase for a period of time greater than the normal cycle length and is reset to near zero at the beginning of the next cycle. A voltage detecting circuit with a preset trip point is attached to the rising voltage. The trip point of the voltage detecting circuit is set to the length of a cycle at the frequency where the desired disconnect should take place. As long as the frequency remains above the desired frequency of disconnect, and the cycle length is shorter than the preset trip point, the circuit will not activate. If the frequency declines and the length of the cycle increases to the length of the set point the circuit will trip and the disconnect switch will open and remain open until reset by starting the voltage source from zero volts (generator shut down).

The additional embodiment is a digital solution. In this embodiment a programmable pulse counter is used to count segments of the cycle length. A crystal-controlled circuit develops a frequency stable pulse string at a frequency more than one hundred times the operating frequency. This pulse string is sent to a programmable counter that has been programmed to the number of pulses that represent the length of a cycle at the desired disconnect frequency. This programmable counter only outputs a disconnect signal if the programmed count has been reached before the next counter reset by the start of the next cycle. The programmable counter is reset at the start of each cycle. Consequently if the length of a cycle is shorter (frequency higher) than the programmed frequency a disconnect signal is not output.

Other methods of detecting low frequency were experimented with, such as a frequency detector similar to an FM radio detector and frequency counters, but the cycle time length method proved to be much faster and the most dependable. It also allows for adjusting the desired frequency of disconnect, is very stable with temperature changes and is cost effective.

This patent application describes two electronic circuits that can be set to a frequency just below the operating frequency of the voltage source called the set point. These circuits turn the load devices on when the voltage source is at operating frequency. When the frequency of the voltage source falls below the set point, the load devices are disconnected or transferred to another voltage source. This can take place before they are drawing excessive current.

### SUMMARY

In accordance with this patent application both embodiments of the Low Frequency Switch are electronic circuits that detect a predetermined low frequency condition of an alternating current power source. When this potentially dangerous condition is detected, each embodiment disconnects or transfers the load to another alternating current power source. Each embodiment is powered from the voltage source it monitors and connects the load to that alternating current power source at power up.

### DRAWINGS AND FIGURES

In the drawings (electronic schematics), the preferred embodiment FIG. 1 components are numbered from 1-54. Modules of the circuit are numbered 55-59. In the additional embodiment FIG. 2 components are numbered from 101-155 and the modules are numbered from 156-160.

FIG. 1 Shows a drawing (electronic schematic) of the preferred embodiment of the Low Frequency Switch with all components numbered.

FIG. 2 Shows a drawing (electronic schematic) of the additional embodiment of the Low Frequency Switch with all components numbered.

FIG. 3 Shows a chart of the frequency code setting for the additional embodiment.

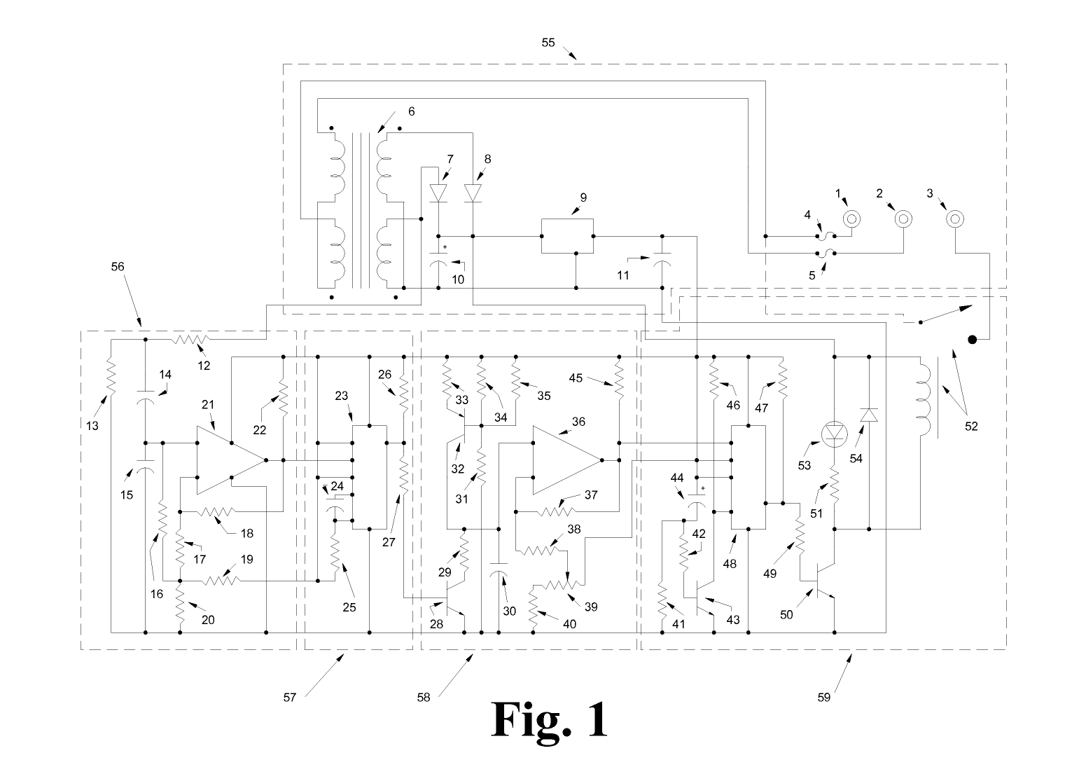

### FIG. 1 REFERENCE NUMBERS

1 interface terminal to connect to one line of the voltage source
2 interface terminal to connect to one line of the voltage source
3 interface terminal to connect external load returned to 2
4 fuse 0.5 amp plus current for external load.
5 fuse 0.5 amp
6 transformer with primary to match source voltage and secondary center tapped 24 volts
7 rectifier 1N4001
8 rectifier 1N4001
9 5 volt regulator
10 electrolytic capacitor 1000 micro farad 35 volts
11 disc capacitor 0.1 micro farad 50 volts
12 2.2 K resistor 0.25 W
13 100 ohm resistor 0.25 W
14 0.47 micro farad capacitor 50 volts
15 0.023 micro farad capacitor 50 volt
16 8.3 K resistor 0.25 W
17 390 ohm resistor 0.25 W
18 1 meg ohm resistor 0.25 W
19 1 K resistor 0.25 W
20 1 K resistor 0.25 W
21 integrated circuit voltage comparator ½ LM 2903
22 3.9 K resistor 0.25 W
23 integrated circuit TTL one-shot flip flop ½ 74LS123
24 0.1 micro farad capacitor 50 volts
25 10K resistor 0.25 W
26 1K resistor 0.25 W
27 1K resistor 0.25 W
28 NPN transistor MPS8090
29 10 ohm resistor 0.25 W
30 0.1 micro farad capacitor 50 volts temperature stable timing capacitor
31 10K resistor 0.25 W
32 PNP transistor 1N4403
33 27K resistor 0.25 W
34 2.2 K resistor 0.25 W
35 30K TC resistor temperature compensated resistor
36 Integrated circuit voltage comparator ½ LM 2903
37 1 meg ohm resistor 0.25 W
38 1K resistor 0.25 W
39 500 ohm potentiometer multiple turn
40 510 ohm resistor 0.25 W
41 100K resistor 0.25 W
42 4.7K resistor 0.25 W
43 NPN transistor MPS8090
44 10 micro farad capacitor 35 volts
45 3.9K resistor
46 2.2K resistor
47 1K resistor 0.25 W
48 integrated circuit TTL one-shot flip flop ½ 74LS74
49 1K resistor 0.25 W
50 NPN transistor MPS8090
51 680 ohm resistor 0.25 W
52 SPDT relay low current coil PB T75SD112-12
53 LED indicator
54 rectifier 1N4001

### Modules Identified

55 power source for the electronic circuit
56 zero crossing detector
57 pulse shaper
58 timer circuit
59 output latch circuit and relay

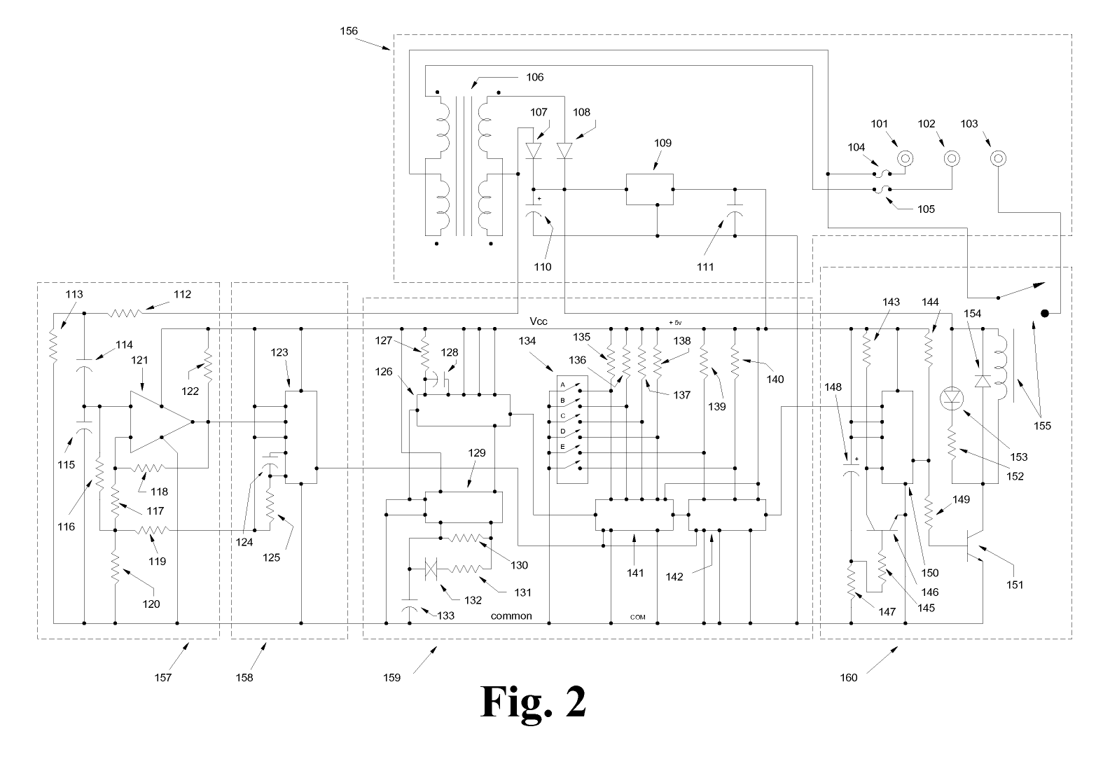

### FIG. 2 COMPONENTS

101 interface terminal to connect to one line of the voltage source
102 interface terminal to connect to one line of the voltage source
103 interface terminal to connect external load returned to 2
104 fuse 0.5 amp plus current for external load.
105 fuse 0.5 amp
106 transformer with primary to match source voltage and secondary center tapped 24 volts
107 rectifier 1N4001
108 rectifier 1N4001
109 5 volt regulator
110 electrolytic capacitor 1000 micro farad 35 volts
111 disc capacitor 1 micro farad 50 volts
112 2.2 K resistor 0.25 W
113 100 ohm resistor 0.25 W
114 0.47 micro farad capacitor 50 volts
115 0.023 micro farad capacitor 50 volt
116 8.2 K resistor 0.25 W
117 390 ohm resistor 0.25 W
118 1 meg ohm resistor 0.25 W
119 1 K resistor 0.25 W
120 1 K resistor 0.25 W
121 integrated circuit voltage comparator ½ LM 2903
122 3.9 K resistor 0.25 W
123 integrated circuit TTL one-shot flip flop ½ 74LS123
124 0.001 micro farad capacitor 50 volts
125 4.7K resistor 0.25 W
126 integrated circuit TTL one-shot flip flop ½ 74LS123
127 4.7K resistor 0.25 W
128 0.001 micro farad capacitor 50 volts
129 integrated circuit TTL oscillator and ripple counter mc14060
130 10 meg resistor 0.25 W
131 100 ohm resistor 0.25 W
132 quartz crystal 4.096 mhz
133 27 pf npo capacitor
134 program switch block containing 6 spst switches
135 3.9K resistor 0.25 W
136 3.9K resistor 0.25 W
137 3.9K resistor 0.25 W
138 3.9K resistor 0.25 W
139 3.9K resistor 0.25 W
140 3.9K resistor 0.25 W
141 integrated circuit TTL divide by N counter 741s193
142 integrated circuit TTL divide by N counter 741s193
143 2.2K resistor 0.25 W
144 1K resistor 0.25 W
145 4.7K resistor 0.25 W
146 NPN transistor mps 8090
147 100K resistor 0.25 W
148 10 micro farad capacitor 35 volt
149 1K resistor 0.25 W
150 integrated circuit TTL flip-flop 741s74
151 NPN transistor mps 8090
152 680 ohm resistor 0.25 W
153 LED indicator light source
154 1N4001 rectifier
155 SPDT relay low current coil PB T75SD112-12

### Modules Identified

156 Power source for the electronic circuit
157 zero crossing detector
158 pulse shaper
159 digital timer
160 output latch and relay

### DETAILED CIRCUIT DESCRIPTION OF FIG. 1 PREFERRED EMBODIMENT

### Power Source for the Electronic Circuit 55

Terminal 1 and Terminal 2 are connected to the alternating current voltage source. The primary of transformer 6 is connected to terminal 1 and terminal 2 through fuse 4 and fuse 5. Transformer 6 has a low voltage center tapped secondary winding that is connected to the anodes of rectifier 7 and rectifier 8. The cathodes of rectifier 7 and rectifier 8 are connected together and attached to the plus side of electrolytic capacitor 10 to filter the rectified alternating current voltage. This point is also connected to the input of five-volt regulator 9. The plus five-volt output of regulator 9 is connected to one side of capacitor 11 and to the rest of the circuit as the plus five-volt source to be called “Vcc”. A connection from the center tap of the secondary of transformer 6 is connected to the negative side of filter capacitor 10, capacitor 11, and to the rest of the circuit as the negative five-volt source to be called “common”.

### Zero Crossing Detector 56

Voltage comparator 21 is used as a zero crossing detector and is powered by connecting the supply inputs to Vcc and common. Resistor 12 is connected between one end of the secondary of transformer 6 and one end of resistor 13. The other end of resistor 13 is connected to common. This decreases the alternating current voltage from the secondary of transformer 6 to a signal voltage suitable for input to voltage comparator 21. From the junction of resistor 12 and resistor 13 capacitor 14 is connected to the negative input of voltage comparator 21. Capacitor 15 is connected to the negative input of voltage comparator 21 to common. The pre-described circuit functions as a voltage divider and wave shaping for the signal voltage to the negative input of voltage comparator 21. Resistor 19 and resistor 20 form a voltage divider from Vcc to common to be called ½ Vcc. Resistor 16 places a fixed dc bias voltage on the negative input of voltage comparator 21 from ½ Vcc. Resistor 17 places a dc bias on the positive input of voltage comparator 21 from ½ Vcc. Resistor 19 connected from the positive input of voltage comparator 21 to the output of comparator 21 creates a small historicizes to prevent crossover oscillation in voltage comparator 21. Resistor 22 forces the output of voltage comparator 21 to Vcc during the high output state. The output of voltage comparator 21 is a square wave signal with rising and falling edges in consistent alignment with the zero crossing points of the signal voltage.

### Pulse Shaper 57

A plus going pulse of about 450 microseconds is needed to reset the timer part of this circuit at the start of each cycle of the voltage source. One-shot flip-flop 23 is connected to the power source Vcc and common and it outputs the needed pulse. The output pulse of voltage comparator 21 is connected to the A input (the falling edge input) of one-shot flip-flop 23. The falling edge configuration is established on one-shot flip-flop 23 by connecting the clear and the B input to Vcc. Capacitor 24 and resistor 25 are connected to the time set inputs of one-shot flip-flop 23 to determine the output pulse width of about 450 micro seconds. Resistor 26 is used as a pull up on the positive going pulse output of one-shot flip-flop 23. The output pulse rate is equal to the frequency of the alternating current voltage source due to only the falling edge triggering of one-shot flip-flop 23.

### Timer Circuit 58

Resistor 27 is connected between the output of one-shot flip-flop 23 and the base of NPN transistor 28. NPN transistor 28 is used as a reset for the timer circuit. The emitter of NPN transistor 28 is connected to common and the collector of the same is connected to resistor 29 for current limiting. Timing capacitor 30 is connected between common and the other end of resistor 29 and this point is also connected to the collector of PNP transistor 32. The emitter of PNP transistor 32 is connected to one end of resistor 33 and the other end of resistor 33 is connected to Vcc. The base of PNP transistor 32 is connected to common through resistor 31 and to Vcc through resistor 34. Resistor 35 is connected between Vcc and the base of PNP transistor 32. Resistor 35 is used to temperature compensate the circuit. After capacitor 30 is discharged by transistor 28 connected to the pulse shaper it starts to recharge from the constant current circuit of transistor 32. The result is a linear saw tooth wave starting at near zero voltage (common) and rising toward Vcc until capacitor 30 is discharged by the next pulse. The negative input of voltage comparator 36 is connected to the pre-described saw tooth wave at the junction of capacitor 30 resistor 29 and the collector of transistor 32.

The positive input of voltage comparator 36 is connected through resistor 37 to the output of voltage comparator 36 for historicizes. Resistor 38 is connected between the positive input of voltage comparator 36 and the center wiper of pot 39. One end of pot 39 is connected to Vcc and the other end is connected through resistor 40 to common. Resistor 45 is a pull up (to Vcc) for the output of voltage comparator 36. Pot 39 is used to establish the trigger point for the negative input of voltage comparator 36. The timing circuit is set to a cycle time just slightly longer then the cycle time length of the minimum frequency of the load device. If the operating cycle length of the alternating current voltage source is less than the trigger point then the saw tooth wave will be reset before rising to the trigger point. The timing circuit and will not output a pulse to the output latch circuit. If the cycle length of the alternating current voltage source is longer than the trigger point then a pulse will be sent to the output latch circuit.

### Output Latch Circuit and Relay 59

The output of the timing circuit is connected to the clock input of flip-flop 48. Flip-flop 48 is connected to Vcc and common for a power source. Resistor 46 is a pull up for the reset input of flip-flop 48. The collector of NPN transistor 43 is connected to the reset input of flip-flop 48 and the emitter is connected to common. The base of NPN transistor 43 is connected to one end of resistor 42 the other end of resistor 42 is connected to capacitor 44. One end of resistor 41 is connected between the junction of resistor 42 and capacitor 44 and common as a bleed down resistor for capacitor 44. The other end of capacitor 44 is connected to Vcc. This circuit causes the latch to reset to the on state on power up. The preset and D input of flip-flop 48 is connected to Vcc. The output of flip-flop 48 is connected to Vcc through pull up resistor 47 and to the base of NPN transistor 50 through resistor 49. The emitter of NPN transistor 50 is connected to common. The collector of NPN transistor 50 is connected to one end of resistor 51, the anode end of diode 54 and one end of relay 52. The other end of resistor 51 is connected to the cathode end of LED 53. The anode end of LED 53, the cathode end diode 54 and the other end of relay 52, are connected to the junction of the cathode ends of rectifier 7, rectifier 8 and capacitor 10. Relay 52's normally open contacts are connected between the output of fuse 4 and terminal 3. The output latch circuit is reset on power up (starting of the generator) to the on state output of flip-flop 48. This holds relay 52 on (activated) till cycle spacing becomes longer then the timer setting. Then the timer circuit clocks flip-flop 48, removing the current flow through resistor 49 and the base of transistor 50 and the collector stops conducting. Relay 52 is released and the contacts are opened removing the alternating current voltage source from terminal 3. Rectifier 54 prevents energy stored in the coil of relay 52 form damaging transistor 50 when current is removed from the coil. Relay 52 contacts can be used to activate the coil of a larger relay, motor contactor, or serve as a signaling device.

### DETAILED CIRCUIT DESCRIPTION OF FIG. 2 ADDITIONAL EMBODIMENT

### Power Source for the Electronic Circuit 156

Terminal 101 and Terminal 102 are connected to the alternating current voltage source. The primary of transformer 106 is connected to terminal 101 and terminal 102 through fuse 104 and fuse 105. Transformer 106 has a low voltage center tapped secondary winding that is connected to the anode of rectifier 107 and rectifier 108. The cathodes of rectifier 7 and rectifier 8 are connected together and attached to the plus side of electrolytic capacitor 110, to filter the rectified alternating current voltage. This point is also connected to the input pin of five-volt regulator 109. The plus five-volt output of voltage regulator 109 is connected to one end of capacitor 11, and to the rest of the circuit as the plus five-volt source to be called “Vcc”. A connection from the center tap of the secondary of transformer 106 is connected to the negative side of filter capacitor 110, capacitor 111, and to the rest of the circuit as the negative five-volt source to be called “common”.

### Zero Crossing Detector 157

Voltage comparator 121 is used as a zero crossing detector and is powered by connecting the plus supply input to Vcc and the negative supply to common. Resistor 112 is connected between one end of the secondary of transformer 106 and one end of resistor 113. The other end of resistor 113 is connected to common. This decreases the AC voltage from the secondary of transformer 106 to a signal voltage suitable for input to voltage comparator 121. From the junction of resistor 112, resistor 113 and capacitor 114 are connected to the negative input of voltage comparator 121. Capacitor 115 is connected to the negative input of voltage comparator 121 to common. The pre-described circuit functions as a voltage divider and wave shaping for the signal voltage to voltage comparator 121. Resistor 119 and resistor 120 form a voltage divider from Vcc to common to be called ½ Vcc. Resistor 116 places a fixed dc bias voltage on the negative input of voltage comparator 121 from ½ Vcc. Resistor 117 places a dc bias voltage on the positive input of voltage comparator 121 from ½ Vcc. Resistor 119 connected from the positive input of voltage comparator 121 to the output of comparator 121 and creates a small historicizes to prevent crossover oscillation of comparator 121. The output of voltage comparator 121 is a square wave signal with rising and falling edges in consistent alignment with the zero crossing points of the signal voltage.

### Pulse Shaper 158

A plus going pulse of about 2 microseconds is needed to reset the timer part of this circuit. One-shot flip-flop 123 is connected to the power source Vcc and common and outputs the needed pulse. The output pulse of voltage comparator 121 is connected to the A input (the falling edge input) of one-shot flip-flop 123. The falling edge configuration is established on one-shot flip-flop 23 by connecting the clear and the B input to Vcc. Capacitor 124 and resistor 125 are connected to the time set inputs of one-shot flip-flop 123 to determine the out put pulse width of about 2 microseconds. The output pulse rate is equal to the frequency of the alternating current voltage source due to only the falling edge triggering of one-shot flip-flop 123. The negative going pulse from one-shot flip-flop 123 is used to load the D inputs of the counters used in digital timer circuit 158.

### Digital Timer Circuit 159

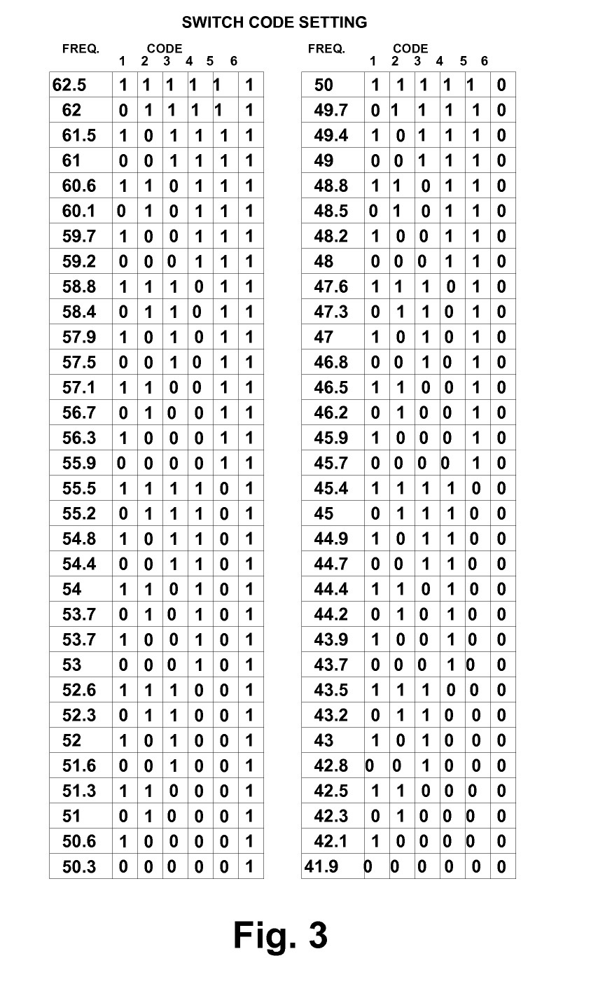

Ripple counter 129 consist of an oscillator and a ripple counter divider and is powered by Vcc and common. One end of 4.096 mhz crystal 132 is connected to the input of the oscillator section of ripple counter 129 and the other end of crystal 132 is connected to the output of the oscillator through resistor 131. Resistor 130 is feed back for the oscillator and capacitor 133 is load capacity for the crystal. The Q9 output of ripple counter 129 of 8000 hz is connected to the A (negative edge trigger) input of one-shot flip-flop 126. B and clear inputs of one-shot flip-flop 126 are connected to Vcc to establish the A input as a negative going input. Capacitor 128 and resistor 127 are connected to one-shot flip-flop 126 to set the output pulse width to about 2 microseconds. Counter 141 and counter 142 are binary up/down programmable counters cascade connected to form a divide by N counter. The two most significant bits of the D inputs of the divide by N counter are programmed by direct connection, with 64 count to common (low state) and 128 count to Vcc (high state). Code switch 134 and pull up resistors 135, 136, 137, 138, 139 and 140 along with the two most significant bits determine the divide by number for the divide by N counter. The six lest significant bits are programmed by code switch 134 and are labeled 1-6 on component 134 of drawing FIG. 2. Codes 1-6 represents binary numbers 1-32 allowing for binary selection of 0-1-2-4-8-16-32 for a total of 64 code settings. With all six switches closed to common (low state) the divide by number (N) is set to 128. When the 8000 hz clock rate is divided by 128 the set frequency is about 62.5 hz. When all code switches are open the counters divide by 191 for a frequency setting of about 41.88 hz. This allows frequency settings for frequencies of 42 hz to 62.5 hz so the same unit will work on 50 hz and 60 hz power. FIG. 3 shows the code chart switch setting for these frequencies.

The load inputs on counter 141 and counter 142 are pulled to common (low state) by the negative going output pulse of one-shot flip-flop 123. This causes a reload of the code switch at the start of each cycle of the operating frequency. Counter 141 and counter 142 are powered from Vcc and common. The count down input clock of counter 141 is connected to the negative going output of one-shot flip-flop 126 sending the 8000 hz, 2 microsecond pluses to the divide by N counter. The borrow output of counter 141 is connected to the count down input of counter 142 making the cascade connection of counter 141 and counter 142 to form the divide by N counter. If the frequency of alternating current voltage source decreases to or below code switch 134 set frequency (increasing the time from the start of one cycle to the start of the next cycle) the divide by N counter counts down to 0 and sends a negative pulse to the barrow output. The barrow output is connected to the clock input of output latch flip-flop 150.

### The Output Latch and Relay 160

Output latch flip-flop 150 is powered by Vcc and common and serves as a latch to lock relay 155 to the on state while the frequency of the alternating current voltage source is above the frequency setting of code switch 134. Prior to start up of the alternating current voltage source, capacitor 148 is discharged. The plus end of capacitor 148 is connected to Vcc and the other end to the base of transistor 146 through resistor 145. Resistor 147 is a bleed down resistor for capacitor 148. At start up of the voltage source the discharged capacitor 148 starts to charge forcing transistor 146 to conduct collector current pulling the reset input of flip-flop 150 to common (state of reset). The charging time of capacitor 148 provides time for the frequency of the alternating current voltage source to come up to normal frequency and reset flip-flop 150. When flip-flop 150 is reset the active high state output forces current through resistor 149 and the base of transistor 151 causing the collector to conduct. This causes LED 153 to conduct through resistor 152 and activates relay 155 closing the contacts applying source voltage to terminal 103. At this point load devices are connected to the voltage source and LED 153 is on indicating power on state.

When the frequency of the voltage source drops below the frequency set by code switch 134 the divide by N counter will output a pulse to the clock of output latch flip-flop 150. The output of flip-flop 150 is unlatched removing the current flow through resistor 149 and the base of transistor 151 stopping the collector from conducting. Relay 155 is released and the contacts are opened removing the source voltage from terminal 103 and LED 153 is turned off. Rectifier 154 prevents energy stored in the coil of relay 155 form damaging transistor 151 when current is removed from the coil. Relay 155 contacts can be used to activate the coil of a larger relay or contactor on power up of the alternating current voltage source. The contacts can also activate a signaling device.

### CONCLUSION

The two embodiments of this patent application describe two different ways to detect a low frequency condition in alternating current voltage. Both of these embodiments have been built and tested and have proved to be very dependable and valuable in protecting frequency sensitive equipment from a low frequency condition of a power source. These embodiments are based on a voltage source frequency of 50 or 60 hz, but would perform the same function with other voltage source frequencies with component changes. This should not limit the scope of this invention.

Other methods of measurement of a cycle length should not limit the scope of this invention. For example, the circuits described in the previous embodiments descriptions describe all the components used by the inventor to perform the task of detecting a low frequency state of an alternating current voltage source. Several of these components could be substituted to other components and still have the same result. Programmable digital integrated circuits and other technologies such as CMOS could replace the TTL technology used by the inventor and perform the same task. Replacing the analog power source module, used by the inventor, with digital switch mode technology may be more cost effective but may cause additional electrical noise. The use microprocessors programmed to measure time periods could also perform these task, but scan times may have an affect on response time. In the preferred embodiment a linear falling voltage in the timing circuit could also perform the same task.

The scope of the invention should be determined by the appended claims, rather then by examples given.

1: A device to disconnect or transfer a load from an alternating current voltage source when the frequency of the alternating current voltage source is reduced below the operating frequency of the load, comprising:
an electronic circuit to detect the frequency of the alternating current voltage source by measuring the length of each cycle of the frequency and disconnecting the load from the alternating current voltage source if a cycle length exceeds a predetermined length.

2: The device of claim 1, comprising:
a circuit that converts each cycle of the alternating current voltage source to a linear rising voltage or a linear falling voltage from a given voltage established at the start of each cycle and rising or falling for a period of time that exceeds the length of a cycle of the alternating current voltage source,
a circuit that monitors the linear rising voltage or the linear falling voltage and outputs an output pulse when the linear rising voltage rises above or the linear falling voltage falls below a human operator entered preset voltage,
an electronic circuit that when receiving the output pulse disconnects or transfers the load devices from the alternating current voltage source until reset by the shut down of the alternating current voltage source.

3: The device of claim 1, comprising:
a digital electronic circuit that produces continuous clock pluses at a rate multiple times the frequency of the alternating current voltage source,
a digital programmable divide by N eight bit counter that inputs the clock pulses and outputs an output pulse if a human operator preset number is reached by the divide by N counter during a cycle of the alternating current voltage source,
an electronic circuit that when receiving the output pulse disconnects load devices from the alternating current voltage source or transfers the load devices from the alternating current voltage source until reset by the shut down of the alternating current voltage source.
